(19) United States
(12) Patent Application Publication
(10) Pub. No.: US 2014/0355276 A1
(43) Pub. Date: Dec. 4, 2014

(54) LIGHT EMITTING DEVICE WITH HEAT SINK

(71) Applicant: VENNTIS TECHNOLOGIES LLC, Holland, MI (US)

(72) Inventor: Daniel J. Fisher, Holland, MI (US)

(73) Assignee: VENNTIS TECHNOLOGIES LLC, Holland, MI (US)

(21) Appl. No.: 14/289,825

(22) Filed: May 29, 2014

Related U.S. Application Data
(60) Provisional application No. 61/828,429, filed on May 29, 2013.

(51) Int. Cl. F21V 29/00; F21K 99/00

(52) U.S. Cl. CPC F21V 29/22; F21K 9/30
USPC 362/382

(57) ABSTRACT

A light emitting device includes at least one semiconductor light emitting diode (LED) and a heat sink disposed in close proximity to the at least one LED. The heat sink comprises heat conducting material in a shape having a first portion with a first mass proximate the at least one LED and a second portion with a second mass distal from the at least one LED wherein the second mass is greater than the first mass.

This application claims the benefit of U.S. Provisional Application No. 61/828,429, filed May 29, 2013, which is incorporated herein by reference in its entirety.

### FIELD OF THE INVENTION

This invention relates generally to light sources and the manufacturing of light sources, and more particularly for solid-state light sources.

### BACKGROUND OF THE INVENTION

Incandescent light bulbs direct light in all directions. That is, the filament light source of an incandescent light bulb directs light omnidirectionally. As shown in FIG. 1, current light emitting diode (LED) light bulbs that are replacing incandescent light bulbs typically include a flat LED light source 12 located on top of a heat sink 14. The heat sink 14 dissipates heat generated by the LED light source 12. The LED light source 12 emits light that is substantially unidirectional. The light then diffuses through a globe 16.

The heat sink is conventionally formed such that the diameter of the heat sink proximate to an array of LEDs placed flat on the surface of the substrate 18 of a printed circuit board is relatively large; much larger than the width of the arrays of LEDs. The heat sink 14 then tapers to a smaller diameter as it approaches the screw connection 20 near the distal end of the heat sink 14. Extended between the proximate and distal ends, the heat sink 14 typically include a series of ribs 22 to increase the heat sink surface area to dissipate heat.

Because of the directional nature of a typical LED light source 12, and the presence of a heat sink 14, the typical LED light bulb cannot direct light similar to or in a pattern equivalent to an incandescent light bulb, especially in the downward direction towards the heat sink 14.

Brunt et al. U.S. Pat. No. 8,646,949 discloses a white light LED formed as a volumetric light emitting device where a phosphor blend is molded into a three-dimensional or volumetric light conversion element. The volumetric light emitting device can direct light omnidirectionally similar to an incandescent light filament. However, when placing the volumetric light device in a conventional LED-type heat sink, the large diameter of the heat sink restricts the output light from propagating in a downward direction like an incandescent light bulb.

### BRIEF DESCRIPTION OF THE INVENTION

One aspect of the invention relates to a light emitting device. The light emitting device comprises one or more semiconductor light emitting diodes (LEDs) and a heat sink disposed in close proximity to the LED. The heat sink comprises heat conducting material in a shape having a first portion with a first mass proximate the LED and a second portion with a second mass distal from the LED wherein the second mass is greater than the first mass.

### BRIEF DESCRIPTION OF THE DRAWINGS

In the drawings:

FIG. 1 illustrates a prior art LED light bulb with heat sink.

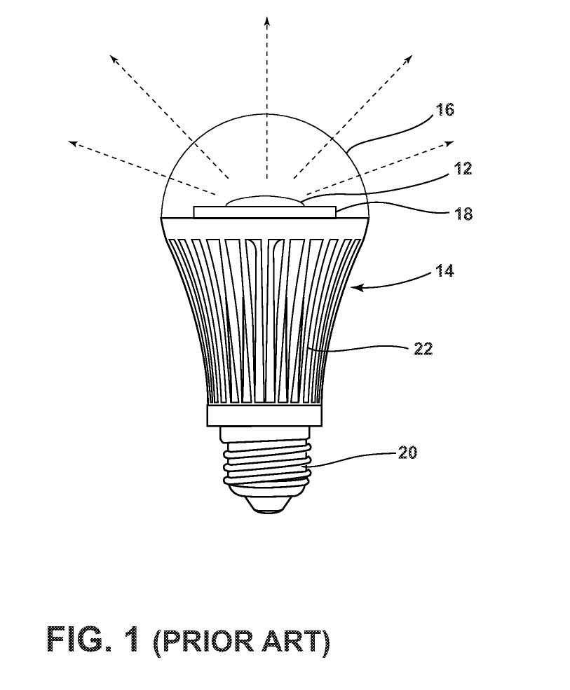

FIG. 2 illustrates a light emitting device with a heat sink according to an embodiment of the present invention.

FIG. 3 illustrates a light emitting device with the heat sink of FIG. 2 where the light source includes a volumetric light emitter.

FIG. 4 illustrates a light emitting device with a heat sink with airflow channels.

FIG. 5 illustrates a bottom view of the light emitting device of FIG. 4.

FIG. 6 illustrates a light emitting device with a heat sink cavity to accommodate a recessed light socket.

FIG. 7 illustrates a light emitting device connected to a harp for connection to a lampshade.

### DESCRIPTION OF EMBODIMENTS OF THE INVENTION

In the background and the following description, for the purposes of explanation, numerous specific details are set forth in order to provide a thorough understanding of the technology described herein. It will be evident to one skilled in the art, however, that the exemplary embodiments may be practiced without these specific details. In other instances, structures and device are shown in diagram form in order to facilitate description of the exemplary embodiments.

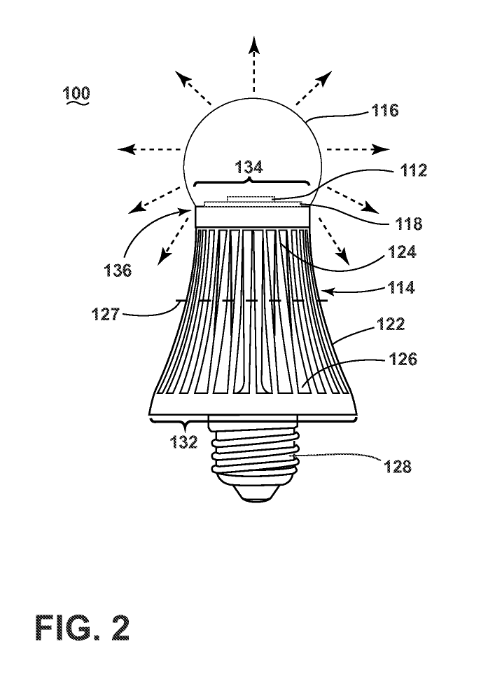

Referring now to FIG. 2, a light emitting device 100, is shown having at least one semiconductor LED light source 112 and a heat sink 114 according to an embodiment of the invention. The heat sink 114 is disposed in close proximity to the LED light source 112.

The heat sink 114 is formed in a shape having a first portion 124 with a mass proximate the LED light source 112 and a second portion 126 with a second mass distal from the LED light source 112. A threaded conductive connector 128 extends from the second portion 126 for connecting the light emitting device 112 to a standard electrical socket.

The mass of the second potion 126 is greater than the mass of the first portion 124. An imaginary interface 127 may be defined between the first portion 124 and the second portion 126 at approximately halfway between the ends of the heat sink 114.

The heat sink 114 comprises a heat conducting material. The heat conducting material may include metal, aluminum or thermoplastic depending upon the implementation.

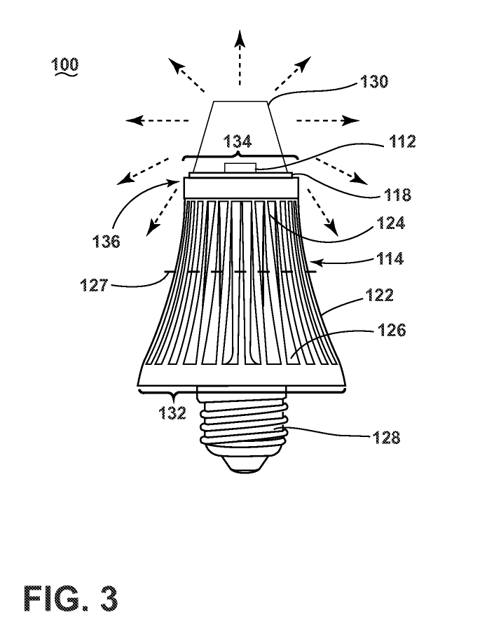

The LED light source 112 may include one or more LEDs or a volumetric light emitter 130 as shown in FIG. 3.

Referring now also to FIG. 3, the heat sink 114 is formed such that the second portion 126 distal from the LED light source 112 has a diameter 132 greater than the diameter 134 proximate the LED light source 112. Preferably the ratio of the second diameter 132 to the first diameter 134 ranges from 1.05:1 to 3.5:1, where the most preferable ratio ranges from 1.75:1 to 2.0:1.

The overall shape of the heat sink 114 is illustrated as a quadric shape, more specifically a truncated hyperboloid. However, other shapes may be used that taper from a larger diameter 132 in the second portion 126 to a smaller diameter 134 in the first portion. That is, the taper between the lower larger diameter 132 and the smaller upper diameter 134 is preferably concave, but could also be straight, convex or formed with segments combining concave, convex and straight geometries.

Forming a heat sink 114 with the smaller diameter 134 proximate the LED light source 112 creates an unrestricted path 136 for light to travel in a direction that is blocked by conventional heat sinks Similarly, forming a heat sink 114 with the larger diameter 132 distal from the LED light source 112 places the necessary material mass, ribs 122 or other means for increasing heat sink surface area to dissipate heat further away from the light source 112 so as not to block the output light.

When coupled with other elements of a light bulb including a globe 116 and a threaded conductive connector 128, the light emitting device 100 replicates the light pattern of an incandescent light bulb using LED technology. Aesthetically, the light bulb is visually attractive.

In most LED lighting applications, the management of heat is critical to the operability of the lighting device. An LED maintaining a lower junction temperature has a longer life expectancy than an LED operated at a higher junction temperature. For lighting applications where LEDs are coated with phosphors, the heat generated by the LED and the heat generated by phosphor down-conversion is typically absorbed and transferred within a heat sink attached either directly to the LED or the printed circuit board (PCB) upon which the LED is mounted. In this way, conventional LED lighting applications rely on the design of the heat sink to maintain the life expectancy of the light source by reducing the LED's junction temperature.

For a typical heat sink design, placement of the larger heat sink mass (i.e. the portion with the larger diameter) near the heat source enables the heat from the LED light source to dissipate into the larger mass but, undesirably, keeps most of the transferred heat near the LED light source. Keeping the junction temperature of the LED light source lower may extend the life of the LED. Therefore, transferring the heat away from the LED light source as far as possible is desirable. A heat sink 114 having the larger diameter 132 of the heat sink 114 and the much larger mass of the heat sink 114 distal from the LED light source 112 stores less heat near the heat source. Embedding a material with a high heat transfer coefficient, such as copper, within the heat sink 114 may supplement the transfer of heat from the first portion 124 of the heat sink to the second portion 126.

With a traditional heat sink having the larger diameter proximate the LED light source and the smaller diameter distal from the LED light source, the dissipated heat along the smaller diameter will begin to rise towards the LED light source. As the heat rises vertically, it contacts the outwardly tapered heat sink, picking up more heat. As heat rises, it continues to contact with the outwardly tapered heat sink and collects even more heat. By the time the rising and heated air passes the upper, larger diameter end of the heat sink, a substantial amount of heat accumulates, thereby keeping the portion of the heat sink closest to the LED light source at a higher temperature. Furthermore, the amount of heat dissipated through convection is directly related to the temperature difference between the heat sink and surrounding air. As the surrounding air temperature increases due to the rising heat collected from air rising from the heat sink, the heat dissipation through convection is minimized because the temperature difference has been reduced. The result is less efficient heat dissipation near the larger diameter portion of the heat sink nearest the LED light source, keeping the LED junction temperature higher than it would be with a more efficient heat sink design.

Conversely, provision of a heat sink 114 with a smaller diameter 134 proximate the LED light source 112 manages heat dissipation more efficiently. As the heat dissipates near the larger heat sink mass and diameter 132 distal from the LED light source 112, heat rises vertically. Since there is no outwardly tapered heat sink elements directly above, the heated air rises vertically without collecting additional heat from the heat sink 114 and has unobstructed vertical air flow for convection. Likewise, as heat dissipates around the middle section of the heat sink, the heated air rises without contacting an outwardly tapered heat sink directly above, thereby eliminating the compounding effect of heat build-up and again has unobstructed vertical air flow for convection. Likewise, as heat dissipates around the lower section of the heat sink, the heated air rises without contacting an outwardly tapered heat sink directly above, thereby eliminating the compounding effect of heat build-up and again has unobstructed vertical air flow for convection. Consequently, the heat sink 114 is cooler near the smaller diameter 134 first portion 124 proximate the LED light source 112, thereby minimizing the LED junction temperature and prolonging the life expectancy of the LED.

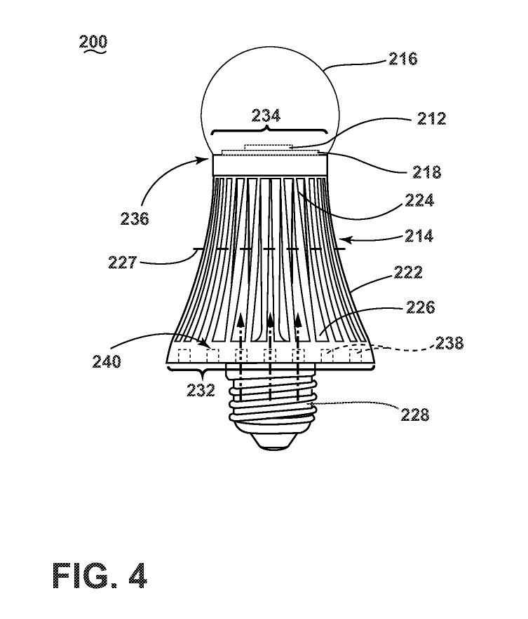

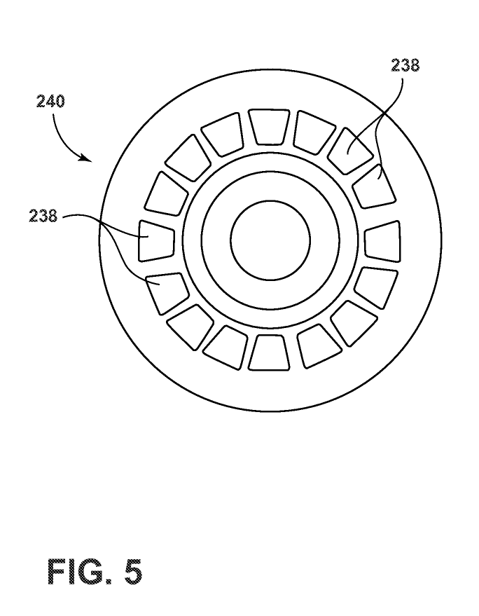

Referring now to FIGS. 4 and 5, a light emitting device 200 is shown having a heat sink 214 with airflow channels 238. Airflow channels 238 integral to the heat sink 214 aid in the heat dissipation. Airflow channels 238 located between the ribs 222 of the heat sink 214 penetrate through the bottom 240 of the heat sink 214. By including airflow channels 238, the surface area of the heat sink 214 increases providing more area for heat dissipation. The airflow channels 238 provide a cooling effect as heated air from the heat sink 214 rises, cooler air is drawn from below the airflow channels over the surface of the heat sink 214.

In contrast, with a traditional LED light bulb heat sink design with the larger diameter proximate the LED light source, usable airflow channels are problematic. At the area of the larger diameter, an airflow channel would open into the globe, allowing insects and dust to accumulate inside the globe area and interfere with the performance of the light bulb. Additionally, with conventional ribbed heat sinks, air becomes trapped or stagnant in the deeper ribbed areas, which minimizes the efficiency of the heat sink for cooling the LED light source.

Conventional incandescent light bulbs screw into a light socket. The globe of the light bulb and the screw connection of the light bulb connect to each other and define the length of the light bulb. With a typical LED light bulb designed to replace an incandescent light bulb, the heat sink is dimensioned to dissipate the heat generated by the LED adds distance between the globe and the screw connection thereby increasing the length of a light bulb with respect to an incandescent light bulb. Consequently many LED light bulbs are incompatible with many light fixtures that are designed with dimensions common for an incandescent light bulb.

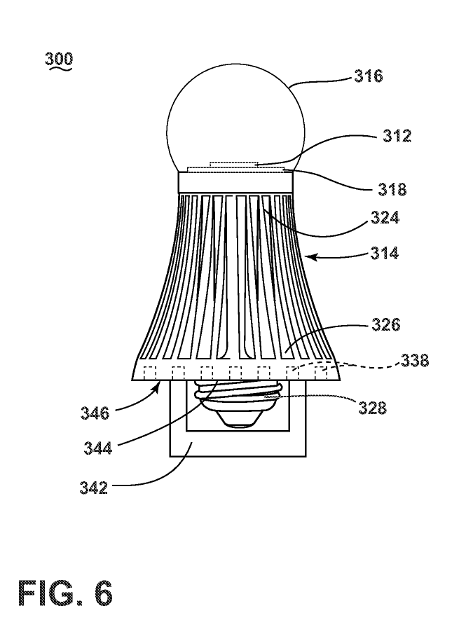

Referring now to FIG. 6, the heat sink 314 may include a cavity 344 in the second portion 326 distal from the LED light source 312 to accommodate a recessed light socket 342. Consequently, the screw connector 328 may be inset into the cavity 344 rather than being mostly flush with the bottom of the heat sink 314. The light emitting device 300 screws into the socket 342 with the socket 342 being inset into the base portion 346 of the heat sink 314. The heat sink 314 overlaps the light socket 342 allowing for the globe 316 to be in closer proximity to the light socket 342 according to the distance prescribed by a conventional incandescent light bulb.

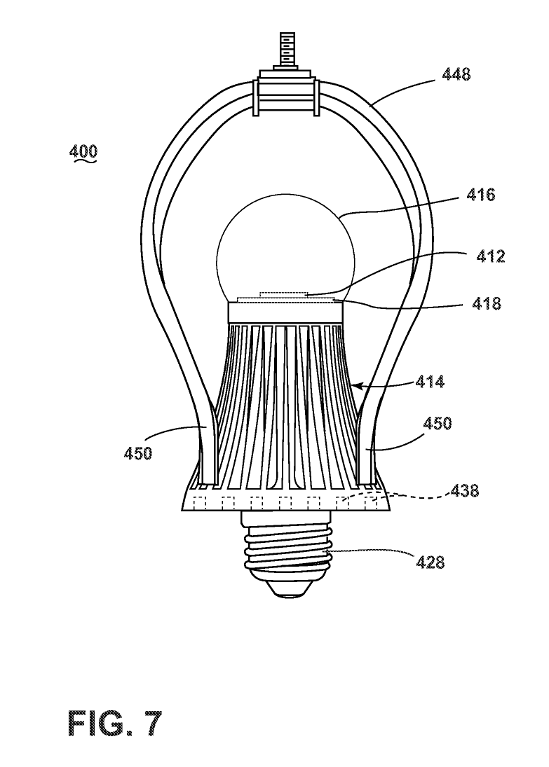

Referring now to FIG. 7, the light emitting device 400 connected to a harp 448 for connection to a lampshade is shown. In some light bulb applications, the light bulb is inserted into a socket of a lamp, which includes a lampshade. Often, the light bulb socket, neck or the light bulb globe itself is part of the attachment points between the lampshade and the lamp base. Conventionally, the lampshade is screwed onto a harp 448 which is then supported by a saddle or socket (neither shown). When installing the light emitting device 400 with the heat sink of FIG. 3, 4 or 6, the distal portion 426 with the larger diameter may interfere with the harp 448 and prevent installation of the lamp. However, the heat sink 414 may become the attachment mechanism for the harp 448. Installing the harp 448 onto the heat sink 414 may include sliding the two harp attachment prongs 450 into the airflow channels 438 discussed above. Alternatively, the heat sink 414 may include similar channels or slots specifically designed to accommodate the harp attachment prongs 450. The slots for the harp attachment prongs 450 may be insulated to prevent heat from transferring from the heat sink 414 to the harp 448.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A light emitting device comprising:
at least one semiconductor light emitting diode (LED); and
heat sink disposed in close proximity to the at least one LED wherein the heat sink comprises heat conducting material in a shape having a first portion with a first mass proximate the at least one LED and a second portion with a second mass distal from the at least one LED wherein the second mass is greater than the first mass.

2. The light emitting device of claim 1 wherein the heat conducting material has a generally quadric shape with the first portion having a first diameter and the second portion having a second diameter, wherein the second diameter is greater than the first diameter.

3. The light emitting device of claim 2 wherein the quadric shape is a truncated hyperboloid.

4. The light emitting device of claim 2 wherein the ratio of the first diameter to the second diameter is ranges from 1.05:1 to 3.5:1.

5. The light emitting device of claim 1 wherein the LED is disposed in a volumetric light emitter.

6. The light emitting device of claim 4 wherein the volumetric light emitter is configured to emit light omni-directionally.

7. The light emitting device of claim 1 further comprising ribs extending from the first portion to the second portion.

8. The light emitting device of claim 1 further comprising a conductive threaded connector extending from the second portion.

9. The light emitting device of claim 1 wherein the heat conducting material is one of metal, aluminum, or thermoplastic.

10. The light emitting device of claim 1 further comprising a cavity at the second portion to accommodate a recessed light socket.

11. A light emitting device comprising:
at least one semiconductor light emitting diode (LED); and
heat sink disposed in close proximity to the at least one LED wherein the heat sink comprises heat conducting material in a shape having a first portion with a first surface area for heat dissipation to air proximate the at least one LED and a second portion with a second surface area for heat dissipation to air distal from the at least one LED wherein the second surface area is greater than the first surface area;
wherein the interface between the first portion and the second portion is approximately halfway between the ends of the heat sink.

12. A light emitting device comprising:
at least one semiconductor light emitting diode (LED); and
heat sink disposed in close proximity to the at least one LED wherein the heat sink comprises heat conducting material in a shape wherein a portion distal from the at least one LED extends laterally outwardly relative to a portion proximate to the at least one LED to provide unobstructed vertical air flow for convection from the distal portion.
